(19) United States
(12) Patent Application Publication
(10) Pub. No.: US 2020/0191207 A1
(43) Pub. Date: Jun. 18, 2020

(54) COUPLING DEVICE

(71) Applicant: HITACHI AUTOMOTIVE SYSTEMS, LTD., Ibaraki (JP)

(72) Inventors: Michihiro KAWASHITA, Tokyo (JP); Kenburaian IKEGUCHI, Hitachinaka-shi (JP); Hiroaki HASHIMOTO, Tokyo (JP); Junichiro ONIGATA, Hitachinaka-shi (JP)

(73) Assignee: HITACHI AUTOMOTIVE SYSTEMS, LTD., Ibaraki (JP)

(21) Appl. No.: 16/629,257

(22) PCT Filed: Jun. 13, 2018
(86) PCT No.: PCT/JP2018/022596

§ 371 Date: Jan. 7, 2020

(30) Foreign Application Priority Data
Jul. 28, 2017 (JP) 2017-146309

(51) Int. Cl. F16D 1/076; F16D 1/033

(52) U.S. Cl. CPC F16D 1/076; F02B 75/048; F16D 1/033

(57) ABSTRACT

A coupling device according to the present invention includes: a first coupling member having first teeth on a disk surface; a second coupling member having second teeth on the disk surface; and a fastening member fastening the first coupling member and the second coupling member at central portions. A reference surface is a surface parallel to the disk surface. A tooth surface angle is an acute angle formed between a tangent line of the meshing tooth surface and a reference surface at a point C on an intersection line between the reference surface and the meshing tooth surface of the first tooth and the second tooth, in a cross section perpendicular to a radial direction of the first coupling member. Tooth surface angles α and β of the first tooth change along the radial direction of the first coupling member.

### TECHNICAL FIELD

The present invention relates to a coupling device.

### BACKGROUND ART

A coupling device is used to connect two parts, for example, for a shaft that transmits torque. Examples of such a coupling device include a Hirth coupling described in PTL 1. The Hirth coupling is constituted by two discoid gears (face gears), in which each of the discoid gears has a plurality of tooth arranged on a flat surface, one gear is a driven-side Hirth coupling, and the other gear is a driving-side Hirth coupling. The teeth of the driven-side Hirth coupling and the teeth of the driving-side Hirth coupling mesh with each other. The Hirth coupling is characterized in that it is possible to transmit excessive torque despite its compact size since the large contact area of tooth surfaces can be secured when fastening the driven-side Hirth coupling to the driving-side Hirth coupling, and that automatic alignment action is obtained at the time of fastening since a tooth length decreases from an outer peripheral portion toward a central portion. For example, PTL 2 describes that a Hirth coupling may be used as a coupling device between an impeller and a rotating shaft that supports the impeller in a rotor of a turbo compressor. In the rotor of the turbo compressor described in PTL 2, the impeller and the rotating shaft can be easily fastened only by applying a fastening force with a tension bolt that penetrates a rotation center of the impeller due to automatic alignment action of the Hirth coupling.

The Hirth coupling can be used for an actuator of a link mechanism for an internal combustion engine, for example. PTL 3 describes an example of the actuator of the link mechanism for the internal combustion engine.

### CITATION LIST

### Patent Literature

PTL 1: JP 2006-022893 A

PTL 2: JP 2008-133745 A

PTL 3: JP 2011-169152 A

### SUMMARY OF INVENTION

### Technical Problem

FIGS. 6A and 6B are cross-sectional views along a radial direction illustrating a fastening portion of a Hirth coupling 24. FIG. 6A is the view illustrating a state before fastening a driven-side Hirth coupling 24a and a driving-side Hirth coupling 24b with a bolt 24c. FIG. 6B is the view illustrating a state after fastening the driven-side Hirth coupling 24a and the driving-side Hirth coupling 24b with the bolt 24c. The bolt 24c serving as a fastening member is inserted through a central portion of the Hirth coupling 24, that is, central portions of the driven-side Hirth coupling 24a and the driving-side Hirth coupling 24b.

As illustrated in FIG. 6A, a tooth surface 24a1 of the driven-side Hirth coupling 24a and a tooth surface 24b1 of the driving-side Hirth coupling 24b are in contact with each other with no gap before fastening the central portion of the Hirth coupling 24 with the bolt 24c.

When fastening the central portion of the Hirth coupling with the bolt 24c at the time of assembling the Hirth coupling 24, a uniform fastening force does not act on the mutually meshing tooth surfaces of the driven-side Hirth coupling 24a and the driving-side Hirth coupling 24b, and an excessive fastening force acts on inner peripheral portions in the vicinity of the bolt 24c. As a result, a frictional force is generated due to high surface pressure in the inner peripheral portions of the driven-side Hirth coupling 24a and the driving-side Hirth coupling 24b, and there occurs no relative slip between the tooth surfaces that causes fretting wear (relative slip of the tooth surfaces between the driven-side Hirth coupling 24a and the driving-side Hirth coupling 24b). However, only a small fastening force acts on outer peripheral portions of the driven-side Hirth coupling 24a and the driving-side Hirth coupling 24b, and thus, a state where the relative slip of the tooth surfaces is likely to occur is formed.

When a large axial force is applied to the bolt 24c in order to increase the fastening performance of the Hirth coupling 24, an excessive compressive force is generated at the central portion of the Hirth coupling 24.

As illustrated in FIG. 6B, when the excessive compressive force is generated in the central portion of the Hirth coupling 24, one end of the inner peripheral portion where no relative slip of the tooth surfaces occurs serves a role as the center of rotation, the outer peripheral portion rises, and the tooth surface 24a1 of the driven-side Hirth coupling 24a and the tooth surface 24b1 of the driving-side Hirth coupling 24b are separated from each other. Since these tooth surfaces are separated so as to draw a circle based on the center of rotation, the tooth of the driving-side Hirth coupling 24b is in contact with the tooth of the driven-side Hirth coupling 24a only at the inner peripheral portion, and the outer peripheral portion thereof rises from the driven-side Hirth coupling 24a. Since the outer peripheral portion of the Hirth coupling 24 has a gap generated between the tooth surface 24a1 of the driven-side Hirth coupling 24a and the tooth surface 24b1 of the driving-side Hirth coupling 24b, no surface pressure is generated, and no binding force due to friction acts. As a result, when a torque load is applied, relative slip occurs between the tooth surfaces of the driven-side Hirth coupling 24a and the driving-side Hirth coupling 24b, and damage in the tooth surfaces caused by the fretting wear becomes significant.

The present invention has been made in view of the above situation, and an object thereof is to provide a coupling device capable of reducing the amount of relative slip generated between tooth surfaces of a driven-side Hirth coupling and a driving-side Hirth coupling when a torque load is applied in a Hirth coupling and suppressing damage in the tooth surfaces caused by fretting wear.

### Solution to Problem

A coupling device according to the present invention includes: a first coupling member that is discoid and has a plurality of first tooth on a disk surface; a second coupling member that is discoid and has a plurality of second tooth meshing with the first teeth of the first coupling member; and a fastening member that is inserted through central portions of the first coupling member and the second coupling member and fastens the first coupling member and the second coupling member. The first teeth extend in a radial direction of the first coupling member. The second tooth extends in a radial direction of the second coupling member. The reference surface is a surface parallel to the disk surface. A tooth surface angle is an acute angle formed between a tangent line of a meshing tooth surface and a reference surface at a point on an intersection line between the reference surface and the meshing tooth surface of the first tooth and the second tooth, in a cross section perpendicular to the radial direction of the first coupling member. The tooth surface angle of the first tooth changes along the radial direction of the first coupling member.

### Advantageous Effects of Invention

According to the present invention, it is possible to provide the coupling device capable of reducing the amount of relative slip generated between the tooth surfaces of the driven-side Hirth coupling and the driving-side Hirth coupling due to the torque load in the Hirth coupling and suppressing the damage in the tooth surfaces caused by the fretting wear.

### BRIEF DESCRIPTION OF DRAWINGS

FIG. 1 is a schematic view of a link mechanism for an internal combustion engine provided with an actuator including a coupling device according to the present invention.

FIG. 2 is a cross-sectional view of an actuator of a link mechanism for an internal combustion engine provided with a coupling device according to a first embodiment.

FIG. 3 is an exploded view of the coupling device (Hirth coupling) according to the first embodiment.

FIG. 4A is a perspective view of a driven-side Hirth coupling, the view illustrating an example of a tooth profile of the driven-side Hirth coupling.

FIG. 4B is a perspective view of a driving-side Hirth coupling, the view illustrating an example of a tooth profile of the driving-side Hirth coupling.

FIG. 5A is a schematic view illustrating a tooth profile of the tooth of a driven-side Hirth coupling in a conventional coupling device.

FIG. 5B is a schematic view illustrating a tooth profile of the tooth of a driving-side Hirth coupling in the conventional coupling device.

FIG. 5C is a schematic view illustrating a tooth profile of the tooth of a driven-side Hirth coupling in the coupling device according to the first embodiment.

FIG. 5D is a schematic view illustrating a tooth profile of the tooth of a driving-side Hirth coupling in the coupling device according to the first embodiment.

FIG. 6A is a cross-sectional view along a radial direction illustrating a fastening portion of the Hirth coupling, the view illustrating a state before fastening the driven-side Hirth coupling and the driving-side Hirth coupling with a bolt.

FIG. 6B is a cross-sectional view along the radial direction illustrating the fastening portion of the Hirth coupling, the view illustrating a state after fastening the driven-side Hirth coupling and the driving-side Hirth coupling with a bolt.

FIG. 7A is a view illustrating a tooth profile when a tooth of the driven-side Hirth coupling and a tooth of the driving-side Hirth coupling mesh with each other before fastening the Hirth coupling with a bolt.

FIG. 7B is a view illustrating a tooth profile of the tooth of the driven-side Hirth coupling and a tooth profile of the tooth of the driving-side Hirth coupling after fastening the Hirth coupling with a bolt.

FIG. 7C is a view illustrating a shape of a tooth profile in three cross sections when a tooth of the driven-side Hirth coupling and a tooth of the driving-side Hirth coupling mesh with each other before fastening the conventional Hirth coupling with a bolt.

FIG. 7D is a view illustrating a shape of a tooth profile in three cross sections after fastening the conventional Hirth coupling with a bolt.

FIG. 7E is a view illustrating a shape of a tooth profile in three cross sections when the tooth of the driven-side Hirth coupling and the tooth of the driving-side Hirth coupling mesh with each other before fastening the Hirth coupling according to the first embodiment with a bolt.

FIG. 7F is a view illustrating a shape of a tooth profile in three cross sections after fastening the Hirth coupling according to the first embodiment with a bolt.

FIG. 8A is a schematic view illustrating a tooth profile of a tooth of a driven-side Hirth coupling in a Hirth coupling according to a second embodiment.

FIG. 8B is a schematic view illustrating a tooth profile of the tooth of a driving-side Hirth coupling in the Hirth coupling according to the second embodiment.

FIG. 9A is a view illustrating a meshing tooth surface of the tooth profile of the driven-side Hirth coupling, according to the second embodiment.

FIG. 9B is a view illustrating a tooth distal surface of the tooth profile illustrated in FIG. 9A, according to the second embodiment.

FIG. 10A is a schematic view illustrating a tooth profile of the tooth of a driven-side Hirth coupling in a Hirth coupling according to a third embodiment.

FIG. 10B is a schematic view illustrating a tooth profile of the tooth of a driving-side Hirth coupling in the Hirth coupling according to the third embodiment.

FIG. 11A is a view illustrating a meshing tooth surface of the tooth profile of the driven-side Hirth coupling, according to the third embodiment.

FIG. 11B is a view illustrating a tooth distal surface of the tooth profile illustrated in FIG. 11A according to the third embodiment.

FIG. 12 is a table showing a relative slip amount obtained by numerical analysis when a tooth profile of a Hirth coupling is a conventional shape, a shape according to the second embodiment, and a shape according to the third embodiment.

### DESCRIPTION OF EMBODIMENTS

A coupling device according to the present invention can be used, for example, for a Hirth coupling provided in an actuator of a link mechanism for an internal combustion engine.

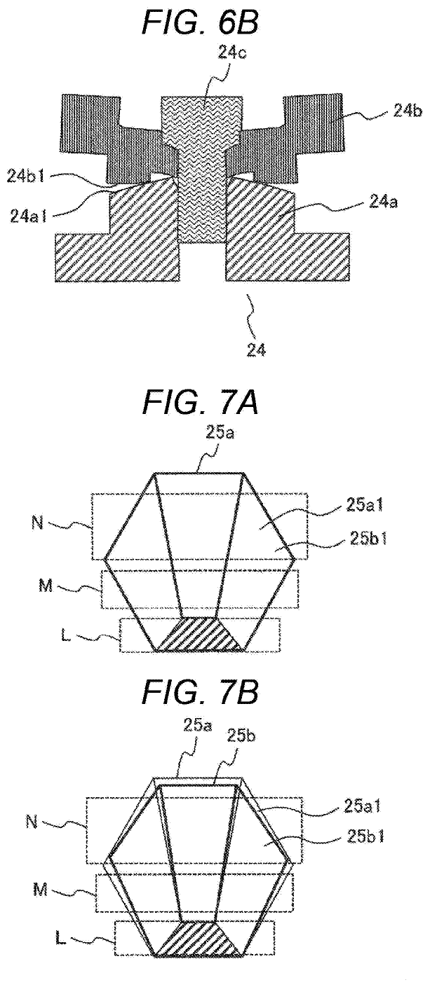

As described with reference to FIGS. 6A and 6B, a high surface pressure is applied to an inner peripheral portion (the radially inner side) in the vicinity of a central portion through which a bolt 24c is inserted, so that a frictional force is generated between a driven-side Hirth coupling 24a and a driving-side Hirth coupling 24b due to a bolt axial force when the central portion is fastened with a bolt 24c at the time of assembling a Hirth coupling 24. However, the surface pressure is not applied to an outer peripheral portion (the radially outer side), so that no binding force caused by friction acts. Consequently, relative slip occurs between tooth surfaces when a torque load is applied, and the tooth surfaces are damaged by fretting wear.

The coupling device (Hirth coupling) according to the present invention can reduce the amount of the relative slip generated between outer peripheral portions of the tooth surfaces of the driven-side Hirth coupling 24a and the driving-side Hirth coupling 24b by an axial force of the bolt 24c and suppress the damage in the tooth surfaces caused by the fretting wear. Further, in the coupling device according to the present invention, the surface pressure is applied to the outer peripheral portion of the Hirth coupling 24 to lower the surface pressure of the inner peripheral portion so as to distribute the fastening force of the bolt 24c from the central portion (the inner peripheral portion) to the outer peripheral portion. Consequently, the axial force of the bolt 24c can be increased, and the fastening force of the bolt 24c can be further increased.

Hereinafter, coupling devices (Hirth couplings) according to embodiments of the present invention will be described.

### First Embodiment

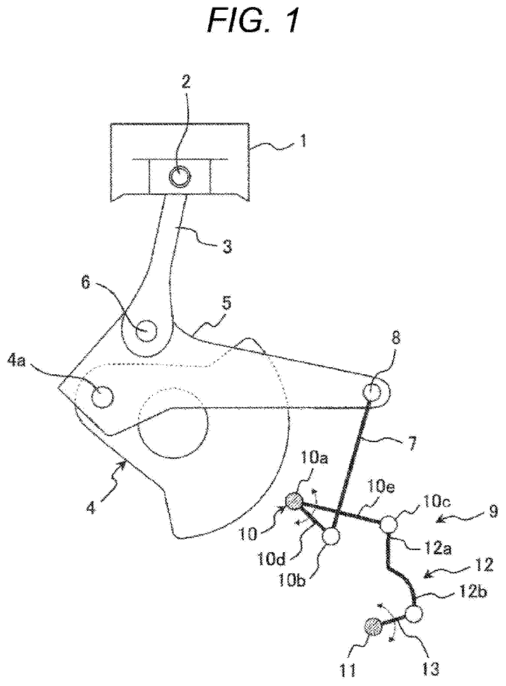

FIG. 1 is a schematic view of a link mechanism for an internal combustion engine provided with an actuator including a coupling device according to the present invention. A basic configuration of this link mechanism is described in, for example, PTL 3 (particularly FIG. 1 and the description thereof), and thus, will be briefly described herein.

An upper end of an upper link 3 is rotatably connected to a piston 1, which reciprocates in a cylinder of a cylinder block of the internal combustion engine, via a piston pin 2. A lower link 5 is rotatably connected to a lower end of the upper link 3 via a connecting pin 6. A crankshaft 4 is rotatably connected to the lower link 5 via a crank pin 4a. In addition, an upper end of a first control link 7 is rotatably connected to the lower link 5 via a connecting pin 8. A lower end of the first control link 7 is connected to a link mechanism 9 having a plurality of link members. The link mechanism 9 is the link mechanism of the internal combustion engine, and includes a first control shaft 10, a second control shaft (actuator control shaft) 11, and a second control link 12.

The first control shaft 10 extends in parallel with the crankshaft 4 extending in a cylinder row direction inside the internal combustion engine. The first control shaft 10 includes a first journal 10a, a control eccentric shaft 10b, an eccentric shaft 10c, a first arm 10d, and a second arm 10e. The first journal 10a is rotatably supported by an internal combustion engine body. The lower end of the first control link 7 is rotatably connected to the control eccentric shaft 10b, and the control eccentric shaft 10b is provided at a position eccentric to the first journal 10a by a predetermined amount. One end 12a of the second control link 12 is rotatably connected to the eccentric shaft 10c, and the eccentric shaft 10c is provided at a position eccentric to the first journal 10a by a predetermined amount. The first arm 10d has one end connected to the first journal 10a and the other end connected to the lower end of the first control link 7. The second arm 10e has one end connected to the first journal 10a and the other end connected to the one end 12a of the second control link 12.

The other end 12b of the second control link 12 is rotatably connected to the one end of the arm link 13. The second control shaft 11 is connected to the other end of the arm link 13 so as not to be relatively movable. The arm link 13 is a separate member from the second control shaft 11.

The second control shaft 11 is rotatably supported, via a plurality of journals, in a housing of an actuator to be described later.

The second control link 12 connects the first control shaft 10 and the second control shaft 11. The second control link 12 has a lever shape, and the one end 12a connected to the eccentric shaft 10c has a substantially linear shape, and the other end 12b connected to the arm link 13 has a curved shape. A distal end of the one end 12a is provided with an insertion hole through which the eccentric shaft 10c is rotatably inserted.

The second control shaft 11 is rotated by a torque transmitted from an electric motor via a wave gear reducer provided in the actuator of the link mechanism for the internal combustion engine. When the second control shaft 11 rotates, the arm link 13 rotates about the second control shaft 11, the first control shaft 10 rotates via the second control link 12, and z position of the lower end of the first control link 7 is changed. Accordingly, a posture of the lower link 5 changes, a stroke position and a stroke amount of the piston 1 in the cylinder change, and accordingly, an engine compression ratio is changed.

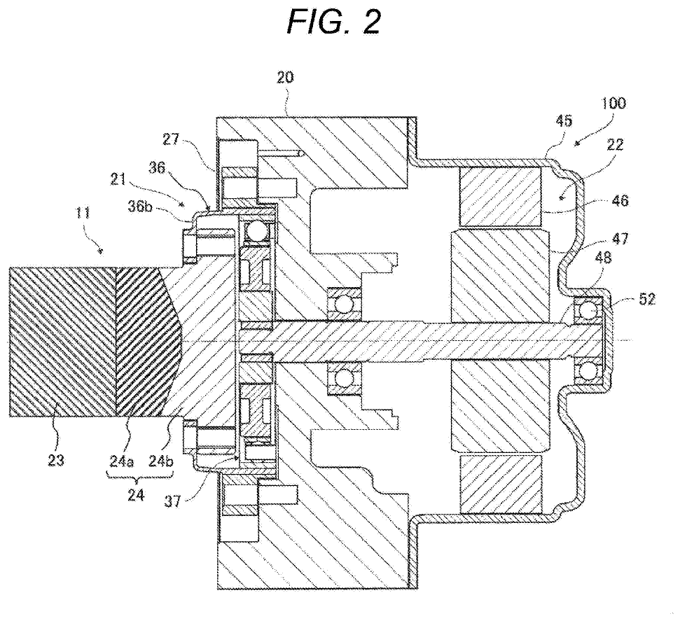

Next, a configuration of the actuator of the link mechanism for the internal combustion engine provided with the coupling device according to the first embodiment of the present invention will be described with reference to FIG. 2.

FIG. 2 is a cross-sectional view of an actuator 100 of the link mechanism for the internal combustion engine provided with the coupling device according to the first embodiment of the present invention. The actuator 100 of the link mechanism for the internal combustion engine includes an electric motor 22, a wave gear reducer 21, a Hirth coupling 24, a housing 20, and the second control shaft 11.

The electric motor 22 is, for example, a brushless motor, and includes a motor casing 45, a coil 46, a rotor 47, and a motor output shaft 48. The motor casing 45 is a bottomed cylindrical member. The coil 46 is fixed to an inner peripheral surface of the motor casing 45. The rotor 47 is rotatably provided on the inner side of the coil 46. The motor output shaft 48 is fixed to the center of the rotor 47 and has one end rotatably supported by a ball bearing 52 provided at the bottom of the motor casing 45.

The wave gear reducer 21 reduces rotational speed of the motor output shaft 48 and transmits a torque of the motor output shaft 48 to the second control shaft 11.

The second control shaft 11 is rotatably supported by the housing 20, and has a shaft body 23 and the Hirth coupling 24. The shaft body 23 extends in an axial direction of the actuator 100. The Hirth coupling 24 is located at one end of the shaft body 23, and has a driven-side Hirth coupling 24a having the same diameter as the shaft body 23 and a driving-side Hirth coupling 24b having a portion extending to the radially outer side of the shaft body 23. The driven-side Hirth coupling 24a and the driving-side Hirth coupling 24b are fastened with a bolt 24c (not illustrated in FIG. 2) at a central portion of the Hirth coupling 24. The shaft body 23 and the driven-side Hirth coupling 24a are integrated to form the second control shaft 11 made of an iron-based metal material. The driving-side Hirth coupling 24b includes a plurality of bolt insertion holes formed at equal intervals in a circumferential direction of the outer peripheral portion. The driving-side Hirth coupling 24b is coupled to a flange 36b of a flexible external gear 36 of the wave gear reducer 21 with the bolt inserted into the bolt insertion hole.

Incidentally, a position of the driven-side Hirth coupling 24a and a position of the driving-side Hirth coupling 24b in the Hirth coupling 24 may be interchanged.

The wave gear reducer 21 includes a rigid internal gear 27, the flexible external gear 36 arranged inside the rigid internal gear 27, a wave generator 37 arranged inside the flexible external gear 36, and an input shaft connected to a central portion of the wave generator 37, and is attached to one end of the electric motor 22. This input shaft is the motor output shaft 48 of the electric motor 22. In addition, an output shaft is connected to the flexible external gear 36. This output shaft is the second control shaft 11 of the actuator 100.

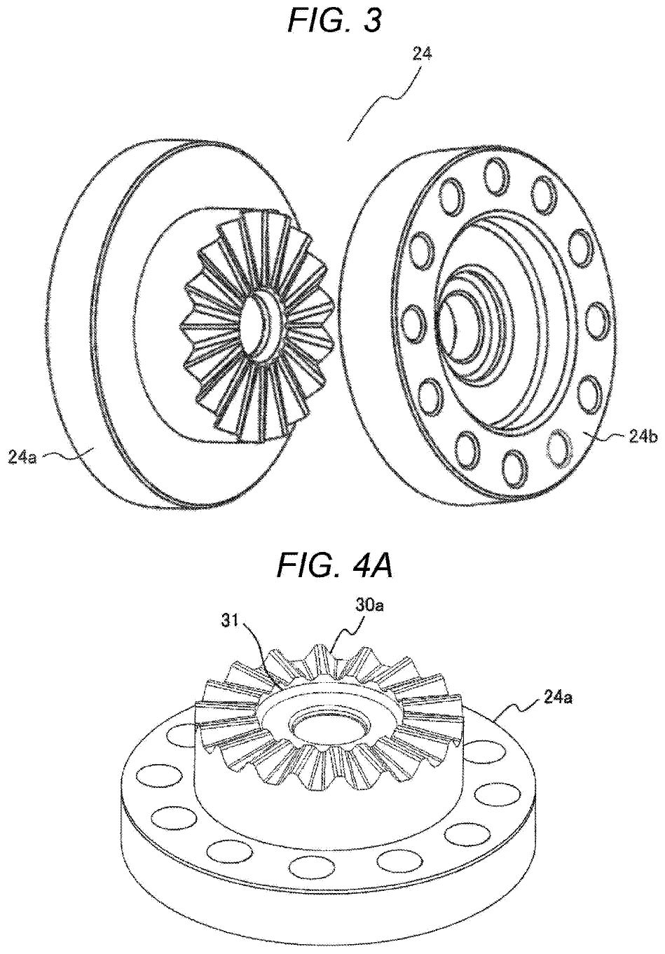

Next, a configuration of the coupling device (Hirth coupling 24) according to the first embodiment of the present invention will be described with reference to FIGS. 3, 4A and 4B, and 5A to 5D.

FIG. 3 is an exploded view of the Hirth coupling 24 according to the present embodiment. The Hirth coupling 24 includes the driven-side Hirth coupling 24a, the driving-side Hirth coupling 24b, and the bolt 24c (see FIGS. 6A and 6B). The bolt 24c, which is a fastening member, is not illustrated in FIG. 3. The driven-side Hirth coupling 24a and the driving-side Hirth coupling 24b are fastened to each other by the bolt 24c inserted through the central portions of the driven-side Hirth coupling 24a and the driving-side Hirth coupling 24b, that is, the central portion of the Hirth coupling 24.

FIG. 4A is a perspective view of the driven-side Hirth coupling 24a, the view illustrating an example of a tooth profile of the driven-side Hirth coupling 24a. FIG. 4B is a perspective view of the driving-side Hirth coupling 24b, the view illustrating an example of a tooth profile of the driving-side Hirth coupling 24b. The driven-side Hirth coupling 24a and the driving-side Hirth coupling 24b are discoid gears, and have a plurality of tooth 30a and tooth 30b, respectively, on a disk surface. The teeth 30a and the teeth 30b are arranged at equal intervals in the circumferential direction of the driven-side Hirth coupling 24a and the driving-side Hirth coupling 24b, respectively, and extend along the radial direction. The teeth 30a and the teeth 30b mesh with each other.

In the driven-side Hirth coupling 24a and the driving-side Hirth coupling 24b, a surface parallel to a surface where the teeth 30a and teeth 30b are provided (a surface parallel to the disk surface of the driven-side Hirth coupling 24a and the driving-side Hirth coupling 24b, that is, a surface perpendicular to a bolt axis direction of the bolt 24c) is referred to as a reference surface 31.

In the teeth 30a and 30b, a tooth surface angle is defined as follows. The tooth surface angle is an angle (an acute angle) formed between a tangent line of a meshing tooth surface and the reference surface 31 at a point on an intersection line between the meshing tooth surface and the reference surface 31, in a cross section perpendicular to the radial direction (tooth extension direction). The meshing tooth surface is a portion of the tooth surfaces that come into contact with each other when the tooth 30a and the tooth 30b mesh with each other.

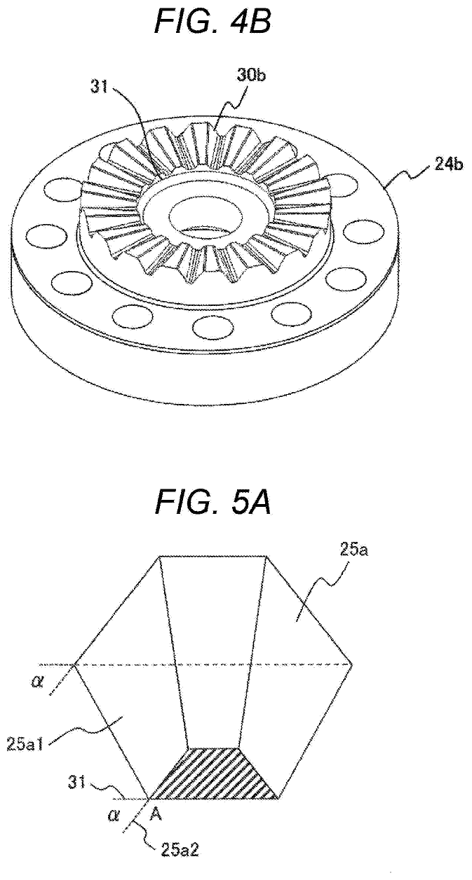

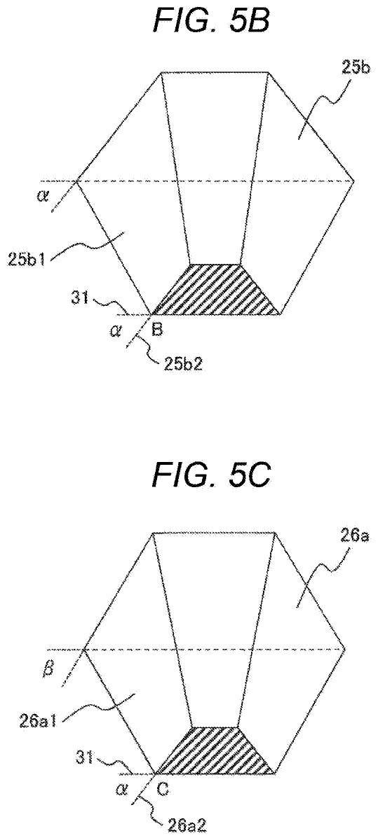

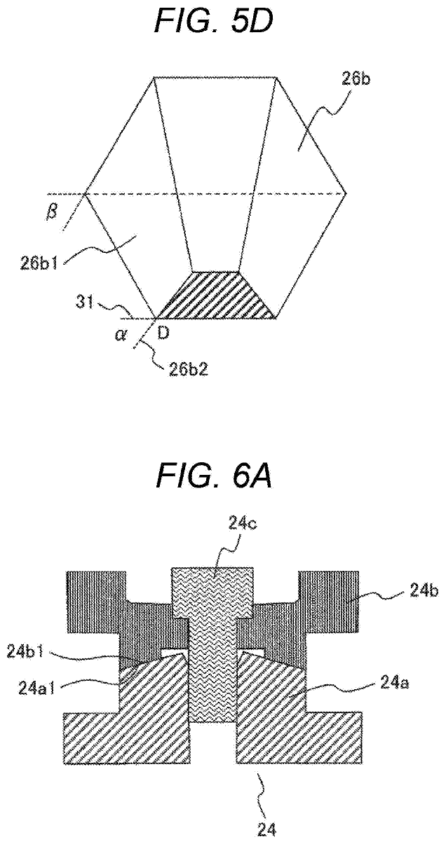

FIG. 5A is a schematic view illustrating a tooth profile 25a of a tooth 30a of a driven-side Hirth coupling 24a in a conventional coupling device (Hirth coupling). FIG. 5B is a schematic view illustrating a tooth profile 25b of a tooth 30b of a driving-side Hirth coupling 24b in the conventional coupling device (Hirth coupling).

In FIG. 5A, a tooth surface angle of a meshing tooth surface 25a1 is an angle formed between a tangent line 25a2 of the tooth surface 25a1 and a reference surface 31 at a point A on an intersection line between the tooth surface 25a1 and the reference surface 31, in a cross section perpendicular to the radial direction of the tooth profile 25a. In FIG. 5B, a tooth surface angle of a meshing tooth surface 25b1 is an angle formed between a tangent line 25b2 of the tooth surface 25b1 and the reference surface 31 at a point B on an intersection line of the tooth surface 25b1 and the reference surface 31, in a cross section perpendicular to the radial direction of the tooth profile 25b.

In the conventional coupling device, the tooth surface angles of the tooth surface 25a1 of the tooth profile 25a of the driven-side Hirth coupling 24a and the tooth surface 25b1 of the tooth profile 25b of the driving-side Hirth coupling 24b have a constant value α regardless of positions of the tooth surfaces 25a1 and 25b1 in the radial direction.

FIG. 5C is a schematic view illustrating a tooth profile 26a of the tooth 30a of the driven-side Hirth coupling 24a in the coupling device (Hirth coupling) according to the present embodiment. FIG. 5D is a schematic view illustrating a tooth profile 26b of the tooth 30b of the driving-side Hirth coupling 24b in the coupling device (Hirth coupling) according to the present embodiment.

In FIG. 5C, a tooth surface angle of a meshing tooth surface 26a1 of the tooth profile 26a of the tooth 30a is an angle (acute angle) formed between a tangent line 26a2 of the tooth surface 26a1 and the reference surface 31 at a point C on an intersection line between the tooth surface 26a1 and the reference surface 31, in a cross section perpendicular to the radial direction of the tooth profile 26a. In FIG. 5D, a tooth surface angle of a meshing tooth surface 26b1 is an angle formed between a tangent line 26b2 of the tooth surface 26b1 and the reference surface 31 at a point D on an intersection line between the tooth surface 26b1 and the reference surface 31, in a cross section perpendicular to the radial direction of the tooth profile 26b. Incidentally, the tooth surface 26a1 and the tooth surface 26b1 are flat surfaces in the present embodiment.

In the coupling device according to the present embodiment, the tooth surface angles of the tooth surface 26a1 of the tooth profile 26a of the driven-side Hirth coupling 24a and the tooth surface 26b1 of the tooth profile 26b of the driving-side Hirth coupling 24b change along the radial direction of the tooth surfaces 26a1 and 26b1. For example, as illustrated in FIGS. 5C and 5D, the tooth surface angles of the tooth surface 26a1 and the tooth surface 26b1 are α in an inner peripheral portion (on the radially inner side), but change along the radial direction to be β in an outer peripheral portion (on the radially outer side) (α<β). Since the tooth 30a of the driven-side Hirth coupling 24a and the tooth 30b of the driving-side Hirth coupling 24b mesh with each other, the tooth surface angles change in the same manner along the radial direction between the tooth surface 26a1 of the tooth 30a and the tooth surface 26b1 of the tooth 30b.

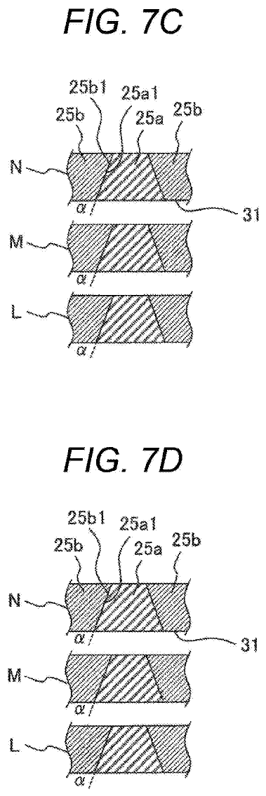

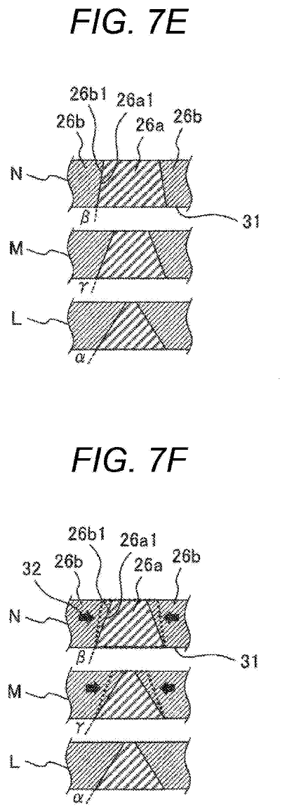

FIG. 7A is a view illustrating the tooth profile 25a of the tooth 30a when the tooth 30a of the driven-side Hirth coupling 24a and the tooth 30b of the driving-side Hirth coupling 24b mesh with each other before fastening the Hirth coupling 24 with the bolt 24c. In FIG. 7A, the meshing tooth surface 25a1 of the tooth profile 25a of the tooth 30a and the meshing tooth surface 25b1 of the tooth profile 25b of the tooth 30b are in contact with each other so as to match each other (in FIG. 7A, the tooth profile 25b is not illustrated since the contour thereof matches the tooth profile 25a).

FIG. 7B is a view illustrating the tooth profile 25a of the tooth 30a of the driven-side Hirth coupling 24a and the tooth profile 25b of the tooth 30b of the driving-side Hirth coupling 24b after fastening the Hirth coupling 24 with the bolt 24c. In FIG. 7B, the meshing tooth surface 25a1 of the tooth profile 25a and the meshing tooth surface 25b1 of the tooth profile 25b do not match each other, and deviation increases from the inner peripheral portion (the radially inner side) toward the outer peripheral portion (the radially outer side). That is, when the Hirth coupling 24 is fastened with the bolt 24c, the tooth surface 25a1 and the tooth surface 25b1 greatly deviate from each other in the outer peripheral portion (on the radially outer side) in the driven-side Hirth coupling 24a and the driving-side Hirth coupling 24b. Thus, no surface pressure is applied to the outer peripheral portion (the radially outer side) between the driven-side Hirth coupling 24a and the driving-side Hirth coupling 24b, and no binding force due to friction acts as described with reference to FIG. 6B.

FIGS. 7A and 7B illustrate three cross sections L, M, and N perpendicular to the radial direction regarding the tooth profile 25a and the tooth profile 25b. The cross sections L, M, and N are located in this order from the inner side to the outer side in the radial direction.

FIG. 7C is a view illustrating shapes of the tooth profile 25a and the tooth profile 25b in the cross sections L, M, and N when the tooth 30a of the driven-side Hirth coupling 24a and the tooth 30b of the driving-side Hirth coupling 24b mesh with each other before fastening the conventional Hirth coupling 24 with the bolt 24c.

FIG. 7D is a view illustrating shapes of the tooth profile 25a and the tooth profile 25b in the cross sections L, M, and N after fastening the conventional Hirth coupling 24 with the bolt 24c.

A description will be given with reference to FIGS. 7C and 7D regarding a change in a meshing state between the meshing tooth surface 25a1 of the tooth profile 25a and the meshing tooth surface 25b1 of the tooth profile 25b when the conventional Hirth coupling 24 is fastened with the bolt 24c.

As illustrated in FIG. 7C, the tooth surface 25a1 of the tooth profile 25a and the tooth surface 25b1 of the tooth profile 25b are in contact with each other before the fastening with the bolt 24c. The tooth surface angle of the tooth surface 25a1 and the tooth surface angle of the tooth surface 25b1 have the constant value α regardless of the radial positions of the tooth surface 25a1 and the tooth surface 25b1, respectively.

The change in the meshing state between the tooth surface 25a1 and the tooth surface 25b1 after the fastening with the bolt 24c will be described with reference to FIG. 7D. After the fastening with the bolt 24c, the tooth surface 25a1 and the tooth surface 25b1 greatly deviate from each other in the outer peripheral portion (on the radially outer side), and the outer peripheral portion of the driving-side Hirth coupling 24b rises from the driven-side Hirth coupling 24a as described with reference to FIGS. 6B and 7B. At this time, the tooth surface angles of the tooth surface 25a1 and the tooth surface 25b1 have the constant value α regardless of the radial positions as illustrated in FIG. 7D, the surface pressure onto the tooth surface 25a1 caused by the tooth surface angle is not generated in the outer peripheral portion. Thus, no binding force due to friction acts between the tooth surface 25a1 and the tooth surface 25b1 in the outer peripheral portion.

FIG. 7E is a view illustrating shapes of the tooth profile 26a and the tooth profile 26b in the cross sections L, M, and N when the tooth 30a of the driven-side Hirth coupling 24a and the tooth 30b of the driving-side Hirth coupling 24b mesh with each other before fastening the Hirth coupling 24 according to the present embodiment with the bolt 24c.

FIG. 7F is a view illustrating shapes of the tooth profile 26a and the tooth profile 26b in the cross sections L, M, and N after fastening the Hirth coupling 24 according to the present embodiment with the bolt 24c.

A description will be given with reference to FIGS. 7E and 7F regarding a change in a meshing state between the meshing tooth surface 26a1 of the tooth profile 26a and the meshing tooth surface 26b1 of the tooth profile 26b when the Hirth coupling 24 according to the present embodiment is fastened with the bolt 24c.

As illustrated in FIG. 7E, the tooth surface 26a1 of the tooth profile 26a and the tooth surface 26b1 of the tooth profile 26b are in contact with each other before the fastening with the bolt 24c. The tooth surface angle of the tooth surface 26a1 and the tooth surface angle of the tooth surface 26b1 differ depending on the radial positions of the tooth surface 26a1 and the tooth surface 26b1, respectively. As illustrated in the cross sections L, M, and N, the tooth surface angle changes from α, to γ, and then to β from the inner peripheral portion toward the outer peripheral portion (from the inner side to the outer side in the radial direction) along the radial direction (α<γ<β).

In the conventional Hirth coupling 24, the tooth surface 25a1 and the tooth surface 25b1 greatly deviate from each other in the outer peripheral portion (on the radially outer side) after the fastening with the bolt 24c, and the outer peripheral portion of the driving-side Hirth coupling 24b rises from the driven-side Hirth coupling 24a.

As illustrated in FIG. 7F, in the Hirth coupling 24 according to the present embodiment, the tooth surface angles of the tooth surface 26a1 and the tooth surface 26b1 differ depending on the radial positions after the fastening with the bolt 24c, and thus, a surface pressure 32 on the tooth surface 26a1 caused by the tooth surface angles of the tooth surfaces 26a1 and 26b1 in contact with each other is also generated in the outer peripheral portion. Depending on the tooth surface angle (that is, depending on the radial position), an angle at which the tooth surface 26a1 receives a torque load of the bolt 24c differs, and the surface pressure 32 received by the tooth surface 26a1 also differs. Since the tooth surface angle increases (α<γ<β) from the inner peripheral portion toward the outer peripheral portion in the example of FIGS. 7E and 7F, the surface pressure 32 received by the tooth surface 26a1 also increases from the inner peripheral portion toward the outer peripheral portion. Incidentally, the cross sections M and N illustrate the tooth profile 26a and the tooth profile 26b whose shapes have been changed by the surface pressure 32 due to the torque load of the bolt 24c.

In the Hirth coupling 24 according to the present embodiment, each of the tooth profile 26a and the tooth profile 26b has the shape in which the tooth surface angle differs depending on the radial position. Thus, the surface pressure 32 caused by a change in the shapes along the radial direction of the tooth profile 26a and the tooth profile 26b is also generated in the outer peripheral portion of the tooth surface 25a1. That is, even if the driving-side Hirth coupling 24b tries to rise from the driven-side Hirth coupling 24a in the outer peripheral portion, the shape of the tooth profile 26a and the tooth profile 26b change along the radial direction, and thus, the tooth surface 26a1 and the tooth surface 26b1 can be brought into contact with each other to generate the surface pressure 32 between these tooth surfaces.

Accordingly, the frictional force is generated between the tooth surface 26a1 and the tooth surface 26b1, and it is possible to suppress the driving-side Hirth coupling 24b from rising from the driven-side Hirth coupling 24a in the Hirth coupling 24 according to the present embodiment. As a result, it is possible to reduce a relative slip generated between the tooth surface 26a1 and the tooth surface 26b1 due to the torque load as compared with the conventional case, and to suppress damage in the tooth surfaces 26a1 and 26b1 caused by fretting wear.

Although the tooth surface angle β in the outer peripheral portion is larger than the tooth surface angle α in the inner peripheral portion in the tooth profile 26a of the tooth 30a of the driven-side Hirth coupling 24a and the tooth profile 26b of the tooth 30b of the driving-side Hirth coupling 24b in the present embodiment, the tooth surface angle may change in an arbitrary manner along the radial direction. For example, even if the tooth surface angle α in the inner peripheral portion is larger than the tooth surface angle β in the outer peripheral portion, the amount of the relative slip generated between the tooth surface 26a1 and the tooth surface 26b1 can be reduced. However, the tooth surface angle β in the outer peripheral portion is desirably larger than the tooth surface angle α in the inner peripheral portion since the fastening force of the bolt 24c acts in the bolt axis direction, and the torque load caused by the fastening of the bolt 24c acts in a direction perpendicular to a plane including the bolt axis. When the tooth surface angle β in the outer peripheral portion is larger than the tooth surface angle α in the inner peripheral portion, the tooth surface receives the surface pressure 32, due to the torque load, in the outer peripheral portion at an angle closer to the vertical than in the inner peripheral portion, a force, which generates the relative slip of the tooth surfaces, acting between the tooth surface 26a1 and the tooth surface 26b1, can be reduced, and it is possible to further reduce the amount of the relative slip generated between the tooth surface 26a1 and the tooth surface 26b1.

It is desirable that the tooth surface angle increase from the inner peripheral portion toward the outer peripheral portion along the radial direction. In addition, it is desirable that the tooth surface angle change monotonously along the radial direction. Therefore, it is more desirable that the tooth surface angle monotonously increase from the inner peripheral portion toward the outer peripheral portion along the radial direction.

Since a tooth length (tooth height) decreases from the outer peripheral portion toward the inner peripheral portion in the Hirth coupling, the tooth profile 26a of the driven-side Hirth coupling and the tooth profile 26b of the driving-side Hirth coupling can be configured such that the tooth length decreases from the outer peripheral portion toward the inner peripheral portion even in the Hirth coupling 24 according to the present embodiment.

The tooth profile 26a may be configured such that a length in the circumferential direction increases (a thickness of the tooth 30a increases) from the inner peripheral portion toward the outer peripheral portion of the driven-side Hirth coupling 24a along the radial direction of the driven-side Hirth coupling 24a. When the length in the circumferential direction increases from the inner peripheral portion toward the outer peripheral portion, automatic alignment action can be obtained when fastening is performed with the bolt 24c. With this automatic alignment action, the driven-side Hirth coupling 24a and the driving-side Hirth coupling 24b can be easily fastened simply by applying a fastening force with the bolt 24c. Similar to the case of the tooth profile 26a, the tooth profile 26b may be configured such that a length in the circumferential direction increases from the inner peripheral portion toward the outer peripheral portion.

### Second Embodiment

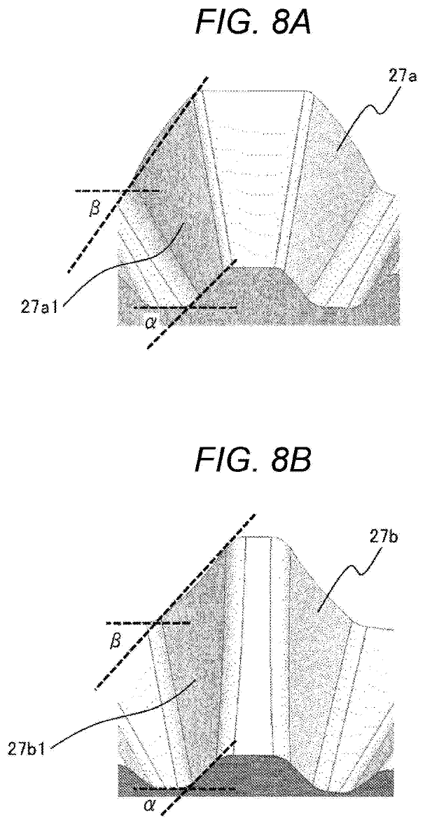

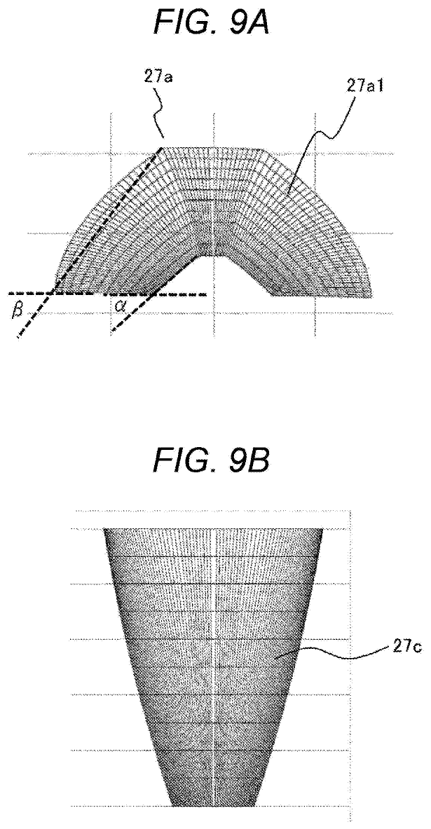

A coupling device (Hirth coupling) according to a second embodiment of the present invention will be described with reference to FIGS. 8A, 8B, 9A, and 9B. A Hirth coupling 24 according to the present embodiment has the same configuration as the Hirth coupling 24 according to the first embodiment, and a configuration (a shape of a tooth surface) different from the Hirth coupling 24 according to the first embodiment will be described hereinafter.

FIG. 8A is a schematic view illustrating a tooth profile 27a of a tooth 30a of a driven-side Hirth coupling 24a in the Hirth coupling 24 according to the present embodiment. FIG. 8B is a schematic view illustrating a tooth profile 27b of a tooth 30b of a driving-side Hirth coupling 24b in the Hirth coupling 24 according to the present embodiment.

In the Hirth coupling 24 according to the present embodiment, similar to the case of the Hirth coupling 24 according to the first embodiment, tooth surface angles of a meshing tooth surface 27a1 of the tooth profile 27a of the driven-side Hirth coupling 24a and a meshing tooth surface 27b1 of the tooth profile 27b of the driving-side Hirth coupling 24b change along the radial direction of the tooth surfaces 27a1 and 27b1. For example, as illustrated in FIGS. 8A and 8B, the tooth surface angles of the tooth surface 27a1 and the tooth surface 27b1 are α in an inner peripheral portion (on the radially inner side), but is β in an outer peripheral portion (on the radially outer side) (α<β).

Although the tooth surface 26a1 and the tooth surface 26b1 are flat surfaces in the first embodiment, the tooth surface 27a1 and the tooth surface 27b1 are curved surfaces in the present embodiment. The tooth surface 27a1 and the tooth surface 27b1 have shapes that can mesh with each other. For example, if one of the tooth surface 27a1 and the tooth surface 27b1 is a curved surface that protrudes to the outer side of the tooth profile, the other is a curved surface that protrudes to the inner side of the tooth profile.

Since the tooth surface 27a1 and tooth surface 27b1 are curved surfaces, the contact area between the tooth surface 27a1 and the tooth surface 27b1 can be secured to be larger than the contact area between the tooth surface 26a1 and the tooth surface 26b1 (both of which are flat surfaces) in the first embodiment. Thus, the total frictional force acting between the tooth surface 27a1 and the tooth surface 27b1 increases in the Hirth coupling 24 according to the present embodiment, and it is possible to more effectively suppress the driving-side Hirth coupling 24b from rising from the driven-side Hirth coupling 24a. As a result, when fastening the Hirth coupling 24 with a bolt 24c, it is possible to further reduce the amount of relative slip generated between the tooth surface 27a1 and the tooth surface 27b1 due to a torque load of the bolt 24c and to more effectively suppress damage in the tooth surfaces 27a1 and 27b1 caused by fretting wear.

FIG. 9A is a view illustrating the meshing tooth surface 27a1 of the tooth profile 27a of the driven-side Hirth coupling 24a. The meshing tooth surface 27a1 illustrated in FIG. 9A is tooth surfaces brought into contact with each other when the tooth 30a of the driven-side Hirth coupling 24a and the tooth 30b of the driving-side Hirth coupling 24b mesh with each other.

The tooth surface 27a1 illustrated in FIG. 9A is obtained by preparing a plurality of cross sections, perpendicular to the radial direction (tooth width) of the tooth profile 27a, in the radial direction, defining a curve in each of the cross sections, and aligning the plurality of curves side by side in the radial direction to be interposed each other. Meanwhile, the plurality of curves is aligned side by side in the radial direction to be interpolated with each other such that the tooth surface angle differs depending on the radial position of the tooth surface 27a1 (changes along the radial direction).

In the present embodiment, the curve defined in the cross section perpendicular to the radial direction of the tooth profile 27a (a curve indicating a shape of the meshing tooth surface 27a1 in the cross section perpendicular to the radial direction of the tooth profile 27a) is expressed by the following Formula (1).

$$\begin{matrix}[ Formula 1 ] & \\ [ \frac{{x}_{bry}}{{y}_{bry}} ] = {{r}_{b} ( {θ}^{2} + 1 )}^{\frac{1}{2}} [ \begin{matrix}sin ( θ - arctan θ ) \\ cos ( θ - arctan θ ) + ( {θ}^{{2}^{1}} - arctan θ )\end{matrix} ] & ( 1 )\end{matrix}$$

Hereinafter, the curve expressed by the Formula (1) will be referred to as “Brian curve”. In the Brian curve, coordinates (x_{bry}, y_{bry}) on the cross section perpendicular to the radial direction of the tooth profile 27a are represented by polar coordinates (r_{b}, θ). The curve indicating the meshing tooth surface 27a1 of the tooth profile 27a is obtained by changing θ as a parameter using the Brian curve. Here, r_{b} is a constant determined by a size of the tooth profile 27a of the tooth 30a, such as a tooth length of the tooth 30a (a height of the tooth 30a).

In the present embodiment, a shape of the meshing tooth surface 27a1 is represented by the Brian curve in an arbitrary cross section perpendicular to the radial direction of the tooth profile 27a. Incidentally, one tooth profile 27a has two meshing tooth surfaces 27a1 connected to a tooth distal surface (a top of a tooth) in a tooth thickness direction (circumferential direction of the Hirth coupling 24), and both the tooth surfaces 27a1 are preferably curved surfaces formed using the Brian curve.

FIG. 9B is a view illustrating a tooth distal surface 27c of the tooth profile 27a illustrated in FIG. 9A. The tooth distal surface 27c is a surface (surface of the top of the tooth) that connects the two meshing tooth surfaces 27a1, and is configured as a flat surface or an arbitrary curved surface. However, the tooth distal surface 27c is configured such that the tooth distal surface 27c is prevented from interfering with a tooth bottom of the driving-side Hirth coupling 24b when the driven-side Hirth coupling 24a meshes with the driving-side Hirth coupling 24b.

Incidentally, the tooth length (tooth height) decreases from the outer peripheral portion toward the inner peripheral portion in the Hirth coupling. Therefore, the tooth profile 27a of the driven-side Hirth coupling and the tooth profile 27b of the driving-side Hirth coupling can be configured such that the tooth length decreases from the outer peripheral portion toward the inner peripheral portion even in the Hirth coupling 24 according to the present embodiment.

The Brian curve is a curve uniquely discovered by the inventors, and is a curve that enables the shape of the meshing tooth surface 27a1 of the tooth profile 27a to swell as much as possible and the surface area of the tooth surface 27a1 (that is, the contact area between the tooth surface 27a1 and the tooth surface 27b1) to be large as much as possible. Therefore, in the Hirth coupling 24 according to the present embodiment in which the shape of the tooth profile 27a is determined using the Brian curve, the total frictional force acting between the tooth surface 27a1 and the tooth surface 27b1 is further increased and the amount of relative slip generated between the tooth surface 27a1 and the tooth surface 27b1 can be further reduced.

Incidentally, the example in which the tooth profile 27a of the driven-side Hirth coupling 24a has the shape expressed using the Brian curve has been described in the present embodiment, but the tooth profile 27b of the driving-side Hirth coupling 24b may have a shape expressed using the Brian curve. As described above, the tooth surface 27a1 of the tooth profile 27a and the tooth surface 27b1 of the tooth profile 27b have shapes that can mesh with each other.

### Third Embodiment

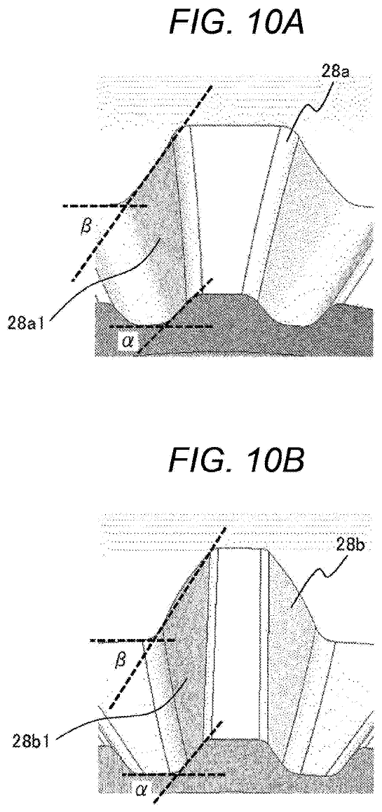

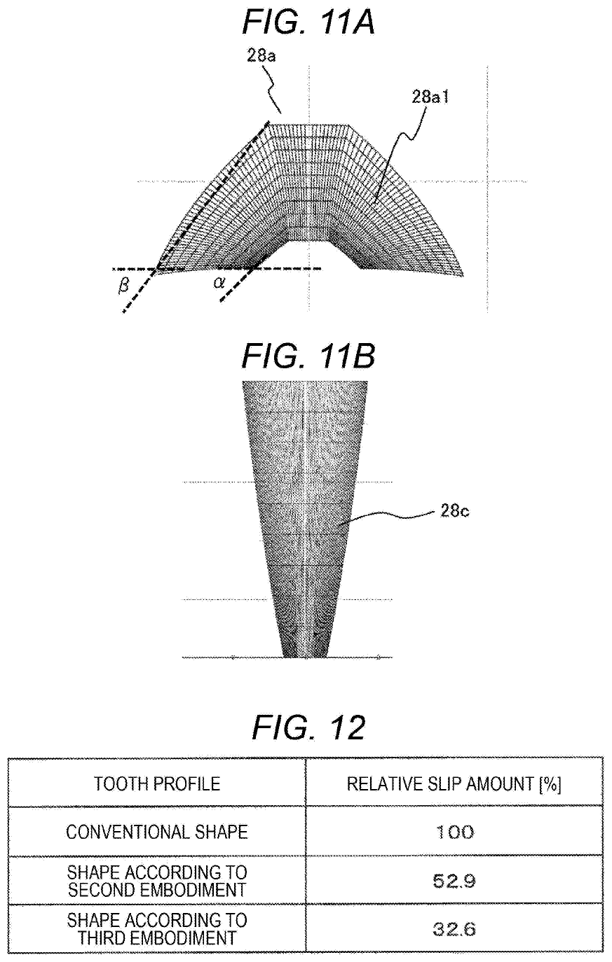

A coupling device (Hirth coupling) according to a third embodiment of the present invention will be described with reference to FIGS. 10A, 10B, 11A, and 11B. A Hirth coupling 24 according to the present embodiment has the same configuration as the Hirth coupling 24 according to the second embodiment, and a configuration (a shape of a tooth surface) different from the Hirth coupling 24 according to the second embodiment will be described hereinafter.

FIG. 10A is a schematic view illustrating a tooth profile 28a of a tooth 30a of a driven-side Hirth coupling 24a in the Hirth coupling 24 according to the present embodiment. FIG. 10B is a schematic view illustrating a tooth profile 28b of a tooth 30b of a driving-side Hirth coupling 24b in the Hirth coupling 24 according to the present embodiment.

In the Hirth coupling 24 according to the present embodiment, similar to the case of the Hirth coupling 24 according to the second embodiment, tooth surface angles of a meshing tooth surface 28a1 of the tooth profile 28a of the driven-side Hirth coupling 24a and a meshing tooth surface 28b1 of the tooth profile 28b of the driving-side Hirth coupling 24b change along the radial direction of the tooth surfaces 28a1 and 28b1. For example, as illustrated in FIGS. 10A and 10B, the tooth surface angles of the tooth surface 28a1 and the tooth surface 28b1 are α in an inner peripheral portion (on the radially inner side), but is β in an outer peripheral portion (on the radially outer side) (α<β).

In the present embodiment, the tooth surface 28a1 and the tooth surface 28b1 are curved surfaces similarly to the second embodiment. Meanwhile, shapes of the curved surfaces are different from those in the second embodiment.

FIG. 11A is a view illustrating the meshing tooth surface 28a1 of the tooth profile 28a of the driven-side Hirth coupling 24a. In the present embodiment, the curve defined in the cross section perpendicular to the radial direction of the tooth profile 28a (a curve indicating a shape of the meshing tooth surface 28a1 in the cross section perpendicular to the radial direction of the tooth profile 28a) is expressed by the following Formula (2).

$$\begin{matrix}[ Formula 2 ] & \\ [ \frac{{x}_{inv}}{{y}_{inv}} ] = {{r}_{b} ( {θ}^{2} + 1 )}^{\frac{1}{2}} [ \begin{matrix}sin ( θ - arctan θ ) \\ cos ( θ - arctan θ )\end{matrix} ] & ( 2 )\end{matrix}$$

Formula (2) is a formula representing an involute curve, and coordinates (xᵢₙᵥ, yᵢₙᵥ) on a cross section perpendicular to the radial direction of the tooth profile 28a are represented by polar coordinates (r_{b}, θ). The curve indicating the meshing tooth surface 28a1 of the tooth profile 28a is obtained by changing θ as a parameter using the involute curve illustrated in the Formula (2). Here, r_{b} is a constant determined by a size of the tooth profile 28a of the tooth 30a, such as a tooth length of the tooth 30a (a height of the tooth 30a).

In the present embodiment, a shape of the meshing tooth surface 28a1 is represented by the involute curve illustrated in Formula (2) in an arbitrary cross section perpendicular to the radial direction of the tooth profile 28a. Incidentally, one tooth profile 28a has two meshing tooth surfaces 28a1 connected to a tooth distal surface (a top of a tooth) in a tooth thickness direction (circumferential direction of the Hirth coupling 24), and both the tooth surfaces 28a1 are preferably curved surfaces formed using the involute curve illustrated in Formula (2).

FIG. 11B is a view illustrating a tooth distal surface 28c of the tooth profile 28a illustrated in FIG. 11A. The tooth distal surface 28c is a surface (surface of the top of the tooth) that connects the two meshing tooth surfaces 28a1, and is configured as a flat surface or an arbitrary curved surface. However, the tooth distal surface 28c is configured such that the tooth distal surface 28c is prevented from interfering with a tooth bottom of the driving-side Hirth coupling 24b when the driven-side Hirth coupling 24a meshes with the driving-side Hirth coupling 24b.

Incidentally, the tooth length (tooth height) decreases from the outer peripheral portion toward the inner peripheral portion in the Hirth coupling. Therefore, the tooth profile 28a of the driven-side Hirth coupling and the tooth profile 28b of the driving-side Hirth coupling can be configured such that the tooth length decreases from the outer peripheral portion toward the inner peripheral portion even in the Hirth coupling 24 according to the present embodiment.

Therefore, in the Hirth coupling 24 according to the present embodiment, similar to the case of Hirth coupling 24 according to the second embodiment, the total frictional force acting between the tooth surface 28a1 and the tooth surface 28b1 is further increased, and the amount of relative slip generated between the tooth surface 28a1 and the tooth surface 28b1 can be further reduced.

In the present embodiment, the shape of the tooth profile 28a is determined using the involute curve illustrated in Formula (2). The involute curve is a curve often used to represent a shape of a gear such as a Hirth coupling. Thus, the Hirth coupling 24 according to the present embodiment can easily manufacture teeth using an existing technique as compared with the Hirth coupling 24 according to the second embodiment.

Next, an effect of the present invention will be described with reference to FIG. 12. Herein, results of numerical analysis performed regarding the Hirth couplings 24 according to the second embodiment and the third embodiment with which the effect of the present invention have been notably acquired are illustrated. In the numerical analysis, a Hirth coupling used in a product to which the Hirth coupling according to the present invention can be applied (for example, an actuator of a link mechanism for an internal combustion engine) is modeled. Then, the amount of relative slip in the model was obtained using general-purpose structural analysis software using the finite element method. The obtained relative slip amount is the amount of relative slip of tooth surfaces between the driven-side Hirth coupling 24a and the driving-side Hirth coupling 24b (a distance of deviation caused by fastening with the bolt 24c) when the maximum torque generated at the time of fastening the central portion of the Hirth coupling 24 with the bolt 24c is applied to the bolt 24c in the modeled product.

FIG. 12 is a table showing the relative slip amount obtained by the numerical analysis when the tooth profile of the Hirth coupling 24 is the conventional shape (the tooth surface angle is constant along the radial direction), the shape according to the second embodiment, and the shape according to the third embodiment. As the conventional tooth profile shape, a tooth profile of the typical Hirth coupling 24 generally used was used. Regarding the tooth profile shapes according to the second embodiment and the third embodiment, the tooth surface angle α in the inner peripheral portion (on the radially inner side) and the tooth surface angle β in the outer peripheral portion (on the radially outer side) were selected to be “α<β” and the tooth surface angle was changed along the radial direction, such that the relative slip amount can be sufficiently reduced. The relative slip amount was determined based on the case of the conventional shape (100%).

As illustrated in FIG. 12, the amount of relative slip between the tooth surfaces that causes fretting wear is reduced to 52.9% in the tooth profile according to the second embodiment, and is reduced to 32.6% in the tooth profile according to the third embodiment as compared with the conventional tooth profile. In this manner, in the Hirth coupling 24 according to the present embodiment, it is possible to reduce the amount of relative slip generated between the tooth surfaces of the driven-side Hirth coupling 24a and the driving-side Hirth coupling 24b due to the torque load of the bolt 24c at the time of fastening with the bolt and to suppress the damage in the tooth surfaces caused by the fretting wear.

Incidentally, the present invention is not limited to the above-described embodiments and may include various modifications. For example, the above-described embodiments have been described in detail in order to describe the present invention in an easily understandable manner, and the present invention is not necessarily limited to modes including the entire configuration that has been described above. In addition, a part of the configuration of a certain embodiment can be replaced with the configuration of another embodiment. In addition, a part of the configuration of a certain embodiment can also additionally accept the configuration of another embodiment. In addition, a part of the configuration of each of the embodiments can be deleted and added or substituted with another configuration.

### REFERENCE SIGNS LIST

1 piston
2 piston pin
3 upper link
4 crankshaft
4a crank pin
5 lower link
6 connecting pin
7 first control link
8 connecting pin
9 link mechanism
10 first control shaft
10a first journal
10b control eccentric shaft
10c eccentric shaft
10d first arm
10e second arm
11 second control shaft
12 second control link
12a one end of second control link
12b other end of second control link
13 arm link
20 housing
21 wave gear reducer
22 electric motor
23 shaft body
24 Hirth coupling
24a driven-side Hirth coupling
24a1 tooth surface
24b driving-side Hirth coupling
24b1 tooth surface
24c bolt
25a tooth profile of conventional driven-side Hirth coupling
25a1 meshing tooth surface
25a2 tangent line of meshing tooth surface
25b tooth profile of conventional driving-side Hirth coupling
25b1 meshing tooth surface
25b2 tangent line of meshing tooth surface
26a tooth profile of driven-side Hirth coupling according to first embodiment
26a1 meshing tooth surface
26a2 tangent line of meshing tooth surface
26b tooth profile of driving-side Hirth coupling according to first embodiment
26b1 meshing tooth surface
26b2 tangent line of meshing tooth surface
27 rigid internal gear
27a tooth profile of driven-side Hirth coupling according to second embodiment
27a1 meshing tooth surface
27b tooth profile of driving-side Hirth coupling according to second embodiment
27b1 meshing tooth surface
27c tooth distal surface of tooth profile of driven-side Hirth coupling
28a tooth profile of driven-side Hirth coupling according to third embodiment
28a1 meshing tooth surface
28b tooth profile of driving-side Hirth coupling according to third embodiment
28b1 meshing tooth surface
28c tooth distal surface of tooth profile of driven-side Hirth coupling
30a tooth of driven-side Hirth coupling
30b tooth of driving-side Hirth coupling
31 reference surface
32 surface pressure
36 flexible external gear
36b flange
37 wave generator
45 motor casing
46 coil
47 rotor
48 motor output shaft
52 ball bearing
100 actuator of link mechanism for internal combustion engine

1. A coupling device comprising:
a first coupling member that is discoid and has a plurality of first tooth on a disk surface;
a second coupling member that is discoid and has a plurality of second tooth meshing with the first teeth of the first coupling member; and
a fastening member that is inserted through central portions of the first coupling member and the second coupling member and fastens the first coupling member and the second coupling member,
wherein the first tooth extends in a radial direction of the first coupling member,
the second tooth extends in a radial direction of the second coupling member, and
when a reference surface is a surface parallel to the disk surface, and
a tooth surface angle is an acute angle formed between a tangent line of a meshing tooth surface and the reference surface at a point on an intersection line between the reference surface and the meshing tooth surface of the first tooth and the second tooth, in a cross section perpendicular to the radial direction of the first coupling member,
the tooth surface angle of the first tooth changes along the radial direction of the first coupling member.

2. The coupling device according to claim 1, wherein
the tooth surface angle of the first tooth increases along the radial direction of the first coupling member from an inner peripheral portion toward an outer peripheral portion of the first coupling member.

3. The coupling device according to claim 1,
wherein
the meshing tooth surface of the first coupling member and the meshing tooth surface of the second coupling member are curved surfaces.

4. The coupling device according to claim 3, wherein
a shape of the meshing tooth surface of the first tooth in the cross section is represented by a curve of Formula (1) and, in Formula (1), coordinates (x_{bry}, y_{bry}) on the cross section are represented by polar coordinates (r_{b}, θ), where r_{b} is a constant determined by a size of the first tooth and θ is a parameter.
$$\begin{matrix}[ Formula 1 ] & \\ [ \frac{{x}_{bry}}{{y}_{bry}} ] = {{r}_{b} ( {θ}^{2} + 1 )}^{\frac{1}{2}} [ \begin{matrix}sin ( θ - arctan θ ) \\ cos ( θ - arctan θ ) + ( {θ}^{{2}^{1}} - arctan θ )\end{matrix} ] & ( 1 )\end{matrix}$$

5. The coupling device according to claim 3, wherein
a shape of the meshing tooth surface of the first tooth in the cross section is represented by a curve of Formula (2) and, in Formula (2), coordinates (xᵢₙᵥ, yᵢₙᵥ) on the cross section are represented by polar coordinates (r_{b}, θ), where r_{b} is a constant determined by a size of the first tooth and θ is a parameter.
$$\begin{matrix}[ Formula 2 ] & \\ [ \frac{{x}_{inv}}{{y}_{inv}} ] = {{r}_{b} ( {θ}^{2} + 1 )}^{\frac{1}{2}} [ \begin{matrix}sin ( θ - arctan θ ) \\ cos ( θ - arctan θ )\end{matrix} ] & ( 2 )\end{matrix}$$

6. The coupling device according to claim 2, wherein
the meshing tooth surface of the first coupling member and the meshing tooth surface of the second coupling member are curved surfaces.

7. The coupling device according to claim 6, wherein
a shape of the meshing tooth surface of the first tooth in the cross section is represented by a curve of Formula (1) and, in Formula (1), coordinates (x_{bry}, y_{bry}) on the cross section are represented by polar coordinates (r_{b}, θ), where r_{b} is a constant determined by a size of the first tooth and θ is a parameter.
$$\begin{matrix}[ Formula 1 ] & \\ [ \frac{{x}_{bry}}{{y}_{bry}} ] = {{r}_{b} ( {θ}^{2} + 1 )}^{\frac{1}{2}} [ \begin{matrix}sin ( θ - arctan θ ) \\ cos ( θ - arctan θ ) + ( {θ}^{{2}^{1}} - arctan θ )\end{matrix} ] & ( 1 )\end{matrix}$$

8. The coupling device according to claim 6, wherein
a shape of the meshing tooth surface of the first tooth in the cross section is represented by a curve of Formula (2) and, in Formula (2), coordinates (xᵢₙᵥ, yᵢₙᵥ) on the cross section are represented by polar coordinates (r_{b}, θ), where r_{b} is a constant determined by a size of the first tooth and θ is a parameter.
$$\begin{matrix}[ Formula 2 ] & \\ [ \frac{{x}_{inv}}{{y}_{inv}} ] = {{r}_{b} ( {θ}^{2} + 1 )}^{\frac{1}{2}} [ \begin{matrix}sin ( θ - arctan θ ) \\ cos ( θ - arctan θ )\end{matrix} ] & ( 2 )\end{matrix}$$
